(19) United States
(12) Patent Application Publication
(10) Pub. No.: US 2007/0070570 A1
(43) Pub. Date: Mar. 29, 2007

(54) Surge protection methods and apparatus

(76) Inventors: Donald B. Turner, Des Plaines, IL (US); Robert J. Bennett, Lewisville, TX (US)

Correspondence Address: CORNING CABLE SYSTEMS LLC, P O BOX 489, HICKORY, NC, 28603, US

(21) Appl. No.: 11/234,880

(22) Filed: Sep. 26, 2005

(51) Int. Cl. H02H 9/06

(52) U.S. Cl. 361/119

(57) ABSTRACT

A method includes positioning a sneak current protective device between at least one of a tip pin and a ring pin, and the telecommunications equipment to be protected, and positioning a high band pass filter in parallel to the sneak current protective device.

### BACKGROUND OF THE INVENTION

1. Field of the Invention

The present invention relates generally to surge protectors for use with, for example, telecommunication lines. More particularly, the invention relates to a surge protector which protects telephone equipment both in a central office (CO) and away from the CO.

2. Technical Background

Wired telecommunications rely on telephone lines to facilitate voice and data transmissions. Because of the proliferation of uses for telephone lines, there has been a growing concern to protect operating personnel and/or connected communications equipment from excessive voltages and currents. Excessive voltages and currents may be caused by, for example, lightning strikes, power line crosses, and/or currents induced from adjacent power lines.

Primary telecommunications protectors, at a minimum, provide overvoltage protection. This is typically done with at least one protection element that is inserted between a conductive tip element of a surge protector and ground. Likewise, typically at least one protection element is inserted between a conductive ring element of the surge protector and ground. When a hazardous overvoltage is present on a line, the overvoltage protection element changes from a high impedance to a low impedance state, effectively shorting the hazardous overvoltage and its associated overcurrent to ground and away from equipment and/or personnel.

There are occasions when an excessive current may be present with no overvoltage. This is typically called a “sneak current” and may occur when there is AC induction on the line or when the tip and ring conductors are somehow shorted, or nearly shorted, to ground. During such a condition, the overvoltage protection element may not short to ground, thereby allowing hazardous overcurrents to pass by the protector to the equipment and/or personnel. Over time, the sneak current condition may cause excessive damage to the telecommunications equipment.

### SUMMARY OF THE INVENTION

In one aspect, the present invention is directed to a method wherein the method includes positioning a sneak current protector device, between at least one of a tip pin and a ring pin, and at least one telecommunications equipment to be protected, and positioning a high band pass filter in parallel to the sneak current protector device.

In another aspect, the present invention is also directed to a circuit, wherein the circuit includes a sneak current protector device between at least one of a tip pin and a ring pin, and at least one telecommunications equipment to be protected, and a high band pass filter in parallel to the sneak current protector device.

In still another aspect, the present invention is still further directed to a protection device, wherein the protection device includes a gas tube configured to provide protection against a surge voltage, and a sneak current protector device configured to provide high band pass filter functionality, said gas tube and the sneak current protector device in a single package.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof.

### BRIEF DESCRIPTION OF THE DRAWINGS

FIG. 1 illustrates a prior art protection circuit.

FIG. 2 illustrates a sneak current device (item 30) with a relatively high capacitance placed in parallel with it, the latter to function as a high band pass filter.

FIG. 3 illustrates the grain boundaries in a PTC sneak current device which is positioned between one OP pin and one CO pin, thereby being positioned between the outside plant cable and the telecommunications equipment to be protected. FIG. 3 also relates the PTC device's internal grain boundaries to the circuit elements of the high band pass filter shown in the schematic diagram portion of the figure.

FIG. 4 illustrates a sneak current device (item 30) positioned between at least one of a tip pin or a ring pin, and at least one telecommunications equipment to be protected, and a network of anti-parallel diodes in parallel with the sneak current device. These diodes provide the relatively high capacitance of a high band pass filter.

FIG. 5 illustrates a partially exploded view of a 5-pin central office or station protector.

### DETAILED DESCRIPTION OF THE PREFERRED EMBODIMENTS

Reference will now be made in detail to the present preferred embodiments of the invention, and examples of which are illustrated in the accompanying drawings.

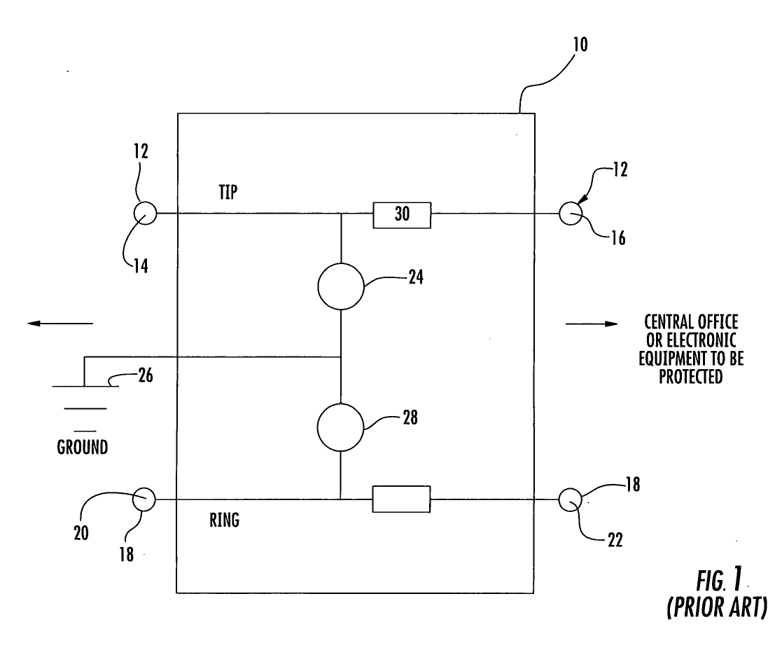

Illustrated in FIG. 1 is a prior art circuit protection circuit 10. Circuit 10 includes a plurality of tip pins or connectors 12. Specifically, circuit 10 includes an outside cabling tip pin 14 and a central office (CO) tip pin 16. This assumes that the protected equipment is in the CO. However, it is contemplated that the benefits of the invention accrue to all telephonic equipment wherever located. Circuit 10 also includes a plurality of ring pins or connectors 18. Specifically, circuit 10 includes an outside cabling ring pin 20 and a central office (CO) ring pin 22. The tip pins 14 and 16 are connected to an electrical ground 26 via a tip overvoltage device 24. The ring pins 20 and 22 are connected to the electrical ground 26 via a ring overvoltage device 28. Circuit 10 is typically employed to protect a telephone system and is herein also referred to as a telephone system protector 10. When an undesirable voltage is induced on the outside plant cabling, on the tip and ring conductors with respect to ground, of sufficient magnitude to damage the electronic equipment being protected, the overvoltage protection devices, 24 and 28, are triggered to their “on” state, thereby reducing the undesirable voltage magnitude to a low, safe level and directing the resulting surge current to ground. In some applications, there can be an undesirable voltage induced on the outside plant cabling which drives a damaging current through the electronic equipment being protected for a long duration, and yet which is not of sufficient magnitude to trigger the overvoltage protection devices, 24 and 28. This condition is known, in the industry, as a “sneak current”. Where this is a concern, the telephone system protector 10 is also equipped with two overcurrent protection devices, marked with reference numeral 30 and connected in the series path of the tip or ring conductors. The overcurrent protection devices are designed to either switch the sneak current to ground or to open up (i.e., break) the series path to prevent the sneak current from continuing to flow to the electronic equipment being protected. The overcurrent protective devices 30, as shown in FIG. 1, depend on either heat being generated in a series resistor to cause either a heat coil's thermally-sensitive component to melt and direct the sneak current to ground, or it depends on heat being generated in its series resistor to cause a positive temperature coefficient (PTC) device to switch to a much higher resistance state and block the sneak current from passing through it. In both cases, the presence of the series resistance has a beneficial protection function. But that same resistance also impedes the telephone or data signal going through the protector.

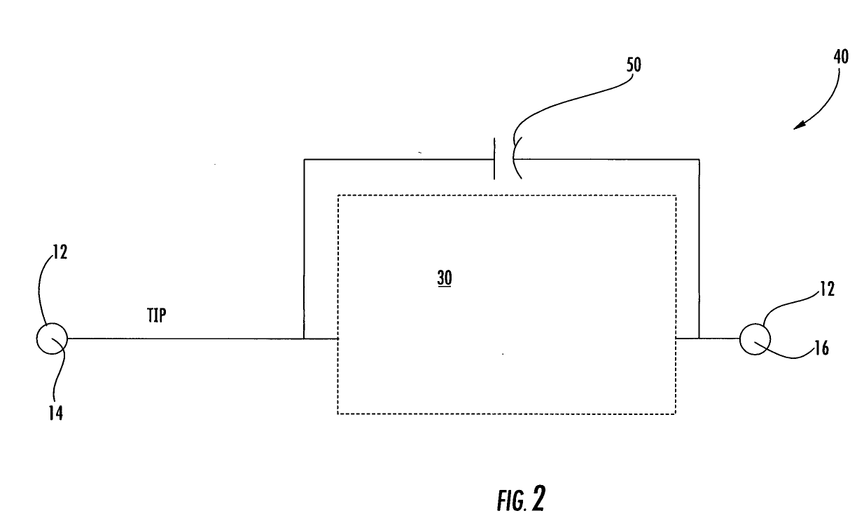

Therefore, FIG. 2 illustrates a circuit 40 with the same sneak current protective features of circuit 10, but with a relatively low capacitance. FIG. 2 illustrates a capacitor 50 wired in parallel to protection device 30. Using an industry standard 4 Ohm heat coil in protector 30, and with the capacitance of capacitor 50 being between about 100 picofarads and about 1000 picofarads then a 16 MHz VDSL signal can be passed with an insertion loss of 1.2 dB to 0.4 dB, respectively. The added capacitance becomes, in effect, a “high pass filter” which allows the desirable high frequency (computer or data) signals to pass through the protector with minimal impedance and minimal reduction in signal strength while blocking undesirable low frequency (60 Hz AC induction) electricity and forcing the latter to flow through the resistance component of protector 30, generate heat, and cause the protector to operate and direct the 60 Hz current to ground. This added capacitance, in parallel with the heat coil resistance on each side (tip and ring) of the protector is one useful embodiment. Capacitor 50 is considered added capacitance because protector 30 includes a capacitive equivalence as well as an inductive equivalence and the resistive equivalence mentioned above. Regarding the resistor that is inherent in protector 30, FIG. 2 therefore illustrates a high band pass filter positioned between at least one of a tip pin and a ring pin, and a telecommunication equipment to be protected, wherein it is the tip pin in FIG. 2, and the high band pass filter is the capacitor 50. FIG. 2 also shows a resistor positioned in parallel to the high band pass filter, wherein the resistor is part of sneak current protector 30.

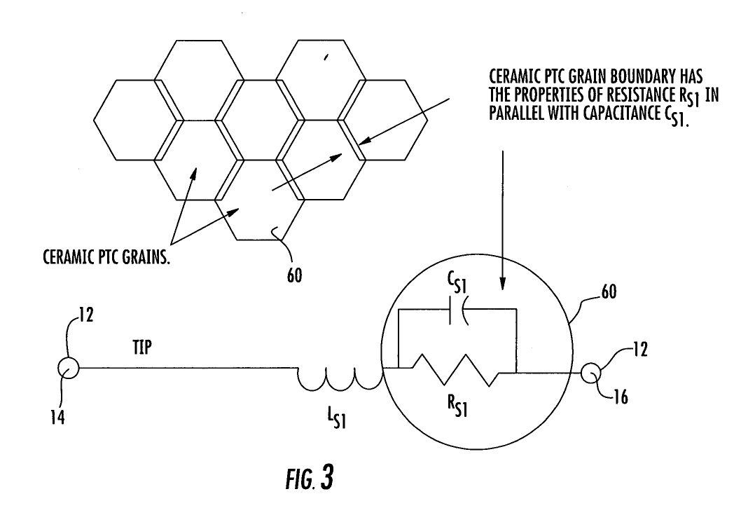

FIG. 3 illustrates the grain structure of a ceramic PTC sneak current protection device and its equivalent circuit schematic which appears as a capacitor or high band pass filter positioned between at least one of a tip pin and a ring pin, and the telecommunications equipment to be protected, and a resistor positioned in parallel to the high band pass filter. However, in FIG. 3, the resistor and capacitor are a single element 60. By element it is not meant to refer to an element of the periodic table. Rather it is meant to mean a single device or structure. In an exemplary embodiment, element 60 is a PTC device, and in one embodiment, PTC 30 is a ceramic PTC, wherein PTC means Positive Temperature Coefficient, such that as temperature rises so does the resistance of the device. While measuring the high frequency transmission properties of ceramic positive temperature coefficient (PTC) sneak current protection devices, it was discovered that they have the desirable low impedance to high frequency signals, and only required a small decrease in resistance RS1 to adequately pass the industry-specified bandwidth for VDSL transmission. This desirable low impedance was due to the capacitance of the grain boundaries between grains of ceramic material of the PTC device, as depicted in FIG. 3, and therefore was not found in the polymer-based PTC devices also presently used in the industry for sneak current protection. Thus, the ceramic-type PTC devices are very useful in passing and protecting a high frequency VDSL system application.

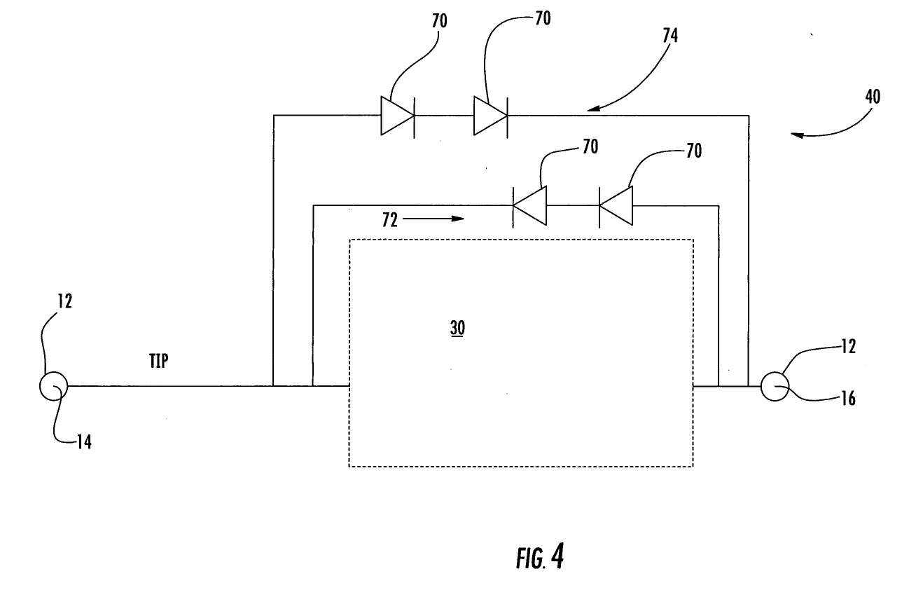

FIG. 4 illustrates another embodiment of a sneak current protector with a parallel-connected high band pass filter positioned between at least one of a tip pin and a ring pin, and the telecommunications equipment to be protected. FIG. 4 illustrates circuit 40 including a plurality of diodes 70 all having a relatively large capacitance. More specifically, circuit 40 includes a first group 72 of stacked diodes 70 and a second group 74 of stacked diodes 70. First group 72 and second group 74 are arranged with opposing polarity so circuit 40 is bi-directional. First group 72 and second group 74 both have capacitance and form a high pass filter. Although FIG. 4 illustrates four diodes 70 and a balanced group size, it is contemplated that the benefits of the invention accrue to circuits with different numbers of diodes and unbalanced groups, and even to uni-directional circuits.

In use, and with reference to both FIGS. 2, 3, and 4, the high frequency signals useful in VDSL are passed to the protected equipment on the protected side (connector 12), while low frequency overcurrents or sneak currents are prevented from reaching connector 12. Although shown only protecting the tip pins 12, the concepts illustrated in FIGS. 2, 3, and 4 are equally applicable to the ring pins. Just as FIG. 1 illustrates protecting both tip and ring pins, the concepts of FIGS. 2, 3, and 4 are implemented, in many cases, similarly. However, there could be some situations when symmetrical protection is not desired.

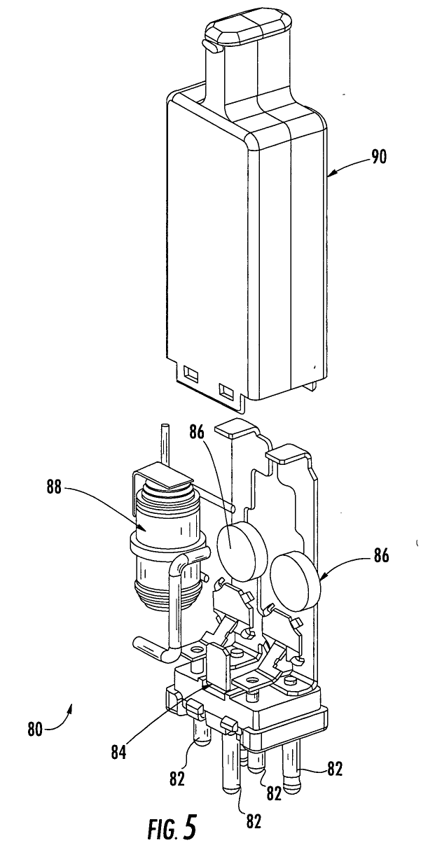

FIG. 5 illustrates a partially exploded view of a central office or station protector 80 employing circuit 40. Protector 80 includes a plurality of pins or contacts 82 which as explained above consist of a CO tip pin, a CO ring pin, a ground pin, an outside cabling ring pin, and an outside cabling tip pin. Pins 82 extend from a main body 84 of protector 80. Also on main body 84 are two PTC devices 86 arranged electrically such that one PTC 86 is electrically connected between the CO tip pin and the outside cabling tip pin, and the other PTC 86 is electrically connected between the CO ring pin and the outside cabling ring pin. A gas tube 88 provides protection in the case of a sharp surge in electricity. However, gas tube 88 does not protect against sneak currents. Rather, as explained above PTCs 86 protect against any sneak current and allow for high band pass filtering (i.e., pass-through of high frequency telecommunications signals). A cover 90 is used to complete protector 80.

In other embodiments of the present invention, the internal components may be rearranged differently than as shown in the drawings. In still other embodiments of the present invention, the central office surge protector may be configured as a 1-pin, a 4-pin, or other suitable configuration of a central office surge protector. In the 1-pin configuration, the single pin is electrically connected to the ground element and the ring and tip elements are configured for inserting pins therein. For example, a tip arm of a tip element of a 1-pin configuration, includes a first end having a portion suitable for inserting a female contact, which in turn is suitable for inserting a pin therein. More specifically, a central office tip contact and an outside plant tip contact are inserted and electrically connected to the first end of the tip arm. Contacts are suitable for inserting electrically conductive pins disposed on a connector block located at a telephone central office. Likewise, the 1-pin configuration includes a similar ring arm of the ring element having a central office ring contact and an outside plant ring contact electrically connected thereto. In other embodiments, a 4-pin configuration can be constructed by electrically connecting a female electrical contact to a suitable ground arm of a ground element with the two pins located on each of the tip and ring elements.

Many modifications and other embodiments of the present invention, within the scope of the appended claims, will become apparent to a skilled artisan. For example, any of the embodiments may be configured as a 4-pin or a 1-pin instead of a 5-pin central office surge protector. Additionally, a pair of two-element gas tubes may replace the single three-element gas tube or vice versa. Electrical contacts may also be plated for environmental protection. Therefore, it is to be understood that the invention is not to be limited to the specific embodiments disclosed and that modifications and other embodiments may be made within the scope of the appended claims. Although specific terms are employed herein, they are used in a generic and descriptive sense only and not for purposes of limitation. The invention has been described with reference to surge protectors for use in a telephone central office or a telephone station application, but the inventive concepts of the present invention are applicable to other protectors as well.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method comprising:
positioning a resistive sneak current protective device between at least one of a tip pin and a ring pin, and at least one telecommunications equipment to be protected; and
positioning a high band pass filter in parallel to the resistive sneak current protective device.

2. A method in accordance with claim 1, wherein said sneak current protective device and said high band pass filter comprises a Positive Thermal Coefficient (PTC) device.

3. A method in accordance with claim 2, wherein said PTC device is composed of a ceramic-based semiconductive material.

4. A method in accordance with claim 1, wherein said positioning a sneak current protective device with high band pass filter comprises:
positioning a first sneak current protective device between the outside cabling plant tip pin and the telecommunications equipment to be protected, and positioning a second sneak current protective device between the outside cabling plant ring pin and the telecommunications equipment to be protected; and
wherein said positioning a high band pass filter in parallel to the sneak current protective device comprises:
positioning two capacitors in parallel one each to the first and second sneak current protective device.

5. A method in accordance with claim 4 further comprising positioning two overvoltage surge protectors one each between the ring pin and an electrical ground and between the tip pin and the electrical ground.

6. A method in accordance with claim 1 further comprising positioning two overvoltage surge protectors one each between the ring pin and an electrical ground and between the tip pin and the electrical ground.

7. A method in accordance with claim 6, wherein the PTC device is composed of a ceramic-based semiconductive material.

8. A method in accordance with claim 1, wherein the high band pass filter comprises at least one capacitor sized such that an insertion loss of a 16 MHz signal is between about 1.2 dB and about 0.4 dB.

9. A method in accordance with claim 8 wherein the sneak current protective device is a heat coil.

10. A method in accordance with claim 1 wherein said high band pass filter comprises a plurality of diodes arranged such that bidirectional electrical high band pass filtering occurs.

11. A circuit comprising:
a sneak current protective device between at least one of a tip pin and a ring pin, and at least one telecommunications equipment to be protected; and
a high band pass filter in parallel to the sneak current protective device.

12. A circuit in accordance with claim 11 comprising
a first sneak current protective device between the tip pin and the telecommunications equipment to be protected, and positioning a second sneak current protective device between the ring pin and the telecommunications equipment to be protected; and
two high band pass filters in parallel one each to the first and second sneak current protective device.

13. A circuit in accordance with claim 11 wherein said high band pass filter comprises a plurality of diodes arranged such that bi-directional electrical high band pass filtering occurs.

14. A circuit in accordance with claim 11, wherein said sneak current protective device and said high band pass filter comprises a Positive Thermal Coefficient (PTC) device.

15. A circuit in accordance with claim 14, wherein said PTC device is composed of a ceramic-based semiconductive material.

16. A circuit in accordance with claim 15 wherein said PTC device is selected such that an insertion loss of a 16 MHz signal is between about 1.2 dB and about 0.4 dB.

17. A protection device comprising:
a gas tube configured to provide protection against a surge voltage; and
a sneak current protective device configured to provide high band pass filtering, said gas tube and said sneak current protector in a single device.

18. A protection device in accordance with claim 17 wherein said high band pass filter comprises a ceramic Positive Thermal Coefficient (PTC) device.

19. A protection device in accordance with claim 18 wherein said PTC device is selected such that an insertion loss of a 16 MHz signal is between about 1.2 dB and about 0.4 dB.

20. A protection device in accordance with claim 17 wherein said high band pass filter is selected such that an insertion loss of a 16 MHz signal is between about 1.2 dB and about 0.4 dB.
